(19) United States
(12) Patent Application Publication
(10) Pub. No.: US 2016/0179964 A1
(43) Pub. Date: Jun. 23, 2016

(54) SYSTEMS AND METHODS FOR PROVIDING NARRATIVES BASED ON SELECTED CONTENT

(71) Applicant: Facebook, Inc., Menlo Park, CA (US)

(72) Inventors: Jeffrey Lin, Palo Alto, CA (US); Alexei Gousev, Menlo Park, CA (US); Arun Vijayvergiya, San Francisco, CA (US); Keito Uchiyama, San Francisco, CA (US); Daniel Isaac Salier-Hellendag, Chicago, IL (US); Arjuna Hayes, Harvard, MA (US); Eric Andrew Shrewsberry, Palo Alto, CA (US)

(21) Appl. No.: 14/575,568

(22) Filed: Dec. 18, 2014

(51) Int. Cl. G06F 17/30

(52) U.S. Cl. CPC G06F 17/30867; G06F 17/3089

(57) ABSTRACT

Systems, methods, and non-transitory computer-readable media can detect that a content item has been published. Information about the content item can be acquired. The information about the content item can be analyzed to determine a confidence metric for the content item. In some cases, the confidence metric can indicate a likelihood that the content item is associated with a narrative. It can be determined that the confidence metric for content item satisfies a specified threshold. The content item can be recommended to be included in the narrative.

### FIELD OF THE INVENTION

The present technology relates to the field of providing content. More particularly, the present technology relates to techniques for providing narratives based on selected content.

### BACKGROUND

Today, people often utilize computing devices (or systems) for a wide variety of purposes. Users can use their computing devices to, for example, interact with one another, access content, share content, and create content. In some cases, a user of a social networking system (or service) can utilize his or her computing device to create and post content. Under conventional approaches, the content can be presented on a profile page of the user. The user's connections within the social networking system can access or view the posted content, as long as the user's privacy settings allow so.

Conventional approaches generally present and organize content items associated with the user in chronological order. However, if multiple related content items are posted at different times, it can be difficult to recognize that the content items are related. Moreover, it can be challenging or tedious to search for content items posted at previous times, especially when forgetting at which times the content items were posted. As such, conventional approaches to presenting and organizing content can be uninteresting, unexpressive, and inefficient, thus reducing the overall user experience associated with using the social networking system.

### SUMMARY

Various embodiments of the present disclosure can include systems, methods, and non-transitory computer readable media configured to detect that a content item has been published. Information about the content item can be acquired. The information about the content item can be analyzed to determine a confidence metric for the content item. In some cases, the confidence metric can indicate a likelihood that the content item is associated with a narrative. It can be determined that the confidence metric for content item satisfies a specified threshold. The content item can be recommended to be included in the narrative.

In one embodiment, the recommending of the content item to be included in the narrative can further comprise recommending a posting of the narrative. The narrative can correspond to a new narrative. The narrative can include at least a portion of the content item.

In one embodiment, one or more user instructions to modify the narrative including the at least the portion of the content item can be received. The narrative can be modified based on the one or more user instructions.

In one embodiment, the narrative can correspond to an existing narrative. The existing narrative can be created prior to detecting that the content item has been published.

In one embodiment, the narrative can be created based on at least one user instruction to create the narrative.

In one embodiment, a selection of at least one other content item to be included in the narrative can be received prior to detecting that the content item has been published. The at least one other content item can be included in the narrative.

In one embodiment, the narrative can include at least one of a subject, a topic, or a theme associated with a user of a social networking system. The likelihood that the content item is associated with the narrative can depend, at least in part, on a level of relevancy of the content item with respect to the at least one of the subject, the topic, or the theme.

In one embodiment, the confidence metric for the content item and the likelihood that the content item is associated with the narrative can increase when the level of relevancy of the content item with respect to the at least one of the subject, the topic, or the theme is higher. In some instances, the confidence metric for the content item and the likelihood that the content item is associated with the narrative can decrease when the level of relevancy of the content item with respect to the at least one of the subject, the topic, or the theme is lower.

In one embodiment, the at least one of the subject, the topic, or the theme can be determined based on at least one of a pattern of posts published by the user or a user command.

In one embodiment, the content item can be a node in a graph infrastructure associated with the user of the social networking system. In some instances, the acquiring of the information about the content item can further comprise performing a search of the graph infrastructure to acquire the information about the content item.

In one embodiment, the acquiring of the information about the content item can further comprise performing batch processing with respect to a data warehouse of the social networking system to acquire the information about the content item from the data warehouse.

In one embodiment, the analyzing of the information about the content item to determine the confidence metric for the content item can further comprise analyzing the information to determine that the content item is associated with one or more defined classifiers. In some cases, the confidence metric can be determined based on the one or more defined classifiers.

In one embodiment, the one or more defined classifiers can include at least one of a travel classifier, an event classifier, or a tag classifier.

In one embodiment, the content item can include at least one of an image, a video, an audio, a check-in, a status update, a shared post, a published post, an article, or text.

In one embodiment, the narrative can be associated with a first user of a social networking system. In some cases, the content item can be published by at least one of the first user or a second user of the social networking system.

In one embodiment, the narrative including at least the content item can be presented at a profile associated with the first user of the social networking system.

In one embodiment, the presenting of the narrative including the content item can further comprise presenting at least one of a map indicating a set of locations associated with the narrative.

In one embodiment, at least one other narrative associated with the first user can be presented. In some cases, at least one of a interface section or an interactive timeline from which the narrative and the at least one other narrative are accessible can be presented.

Many other features and embodiments of the invention will be apparent from the accompanying drawings and from the following detailed description.

### BRIEF DESCRIPTION OF THE DRAWINGS

FIG. 1 illustrates an example system configured to facilitate providing narratives based on selected content, according to an embodiment of the present disclosure.

FIG. 2 illustrates an example narrative module configured to facilitate providing narratives based on selected content, according to an embodiment of the present disclosure.

FIG. 3 illustrates an example content analysis module configured to facilitate providing narratives based on selected content, according to an embodiment of the present disclosure.

FIG. 4 illustrates an example defined classification module configured to facilitate providing narratives based on selected content, according to an embodiment of the present disclosure.

FIG. 5 illustrates an example screenshot associated with providing narratives based on selected content, according to an embodiment of the present disclosure.

FIG. 6 illustrates an example screenshot associated with providing narratives based on selected content, according to an embodiment of the present disclosure.

FIG. 7 illustrates an example screenshot associated with providing narratives based on selected content, according to an embodiment of the present disclosure.

FIG. 8A illustrates an example method associated with providing narratives based on selected content, according to an embodiment of the present disclosure.

FIG. 8B illustrates an example method associated with providing narratives based on selected content, according to an embodiment of the present disclosure.

FIG. 9 illustrates a network diagram of an example system that can be utilized in various scenarios, according to an embodiment of the present disclosure.

FIG. 10 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Narratives Based on Selected Content

People use social networking systems (or services) for various purposes. Users of a social networking system can establish connections, communicate, and interact with one another. Users can also create content, edit content, share content, and access or consume content. In one example, a user of the social networking service can post or publish content items such as status updates, check-ins, pictures, videos, audio files, articles, published posts, shared posts, and text strings. The content posted or published by the user can be presented on a profile page of the user, such as on a timeline which includes a collection of content items associated with the user. The user's connections, for example, can access, view, or consume such content posted on the profile page (e.g., timeline) of the user, as long as the user's privacy settings allow so.

Conventional approaches generally organize content items associated with the user in chronological order. In one example, under conventional approaches, if the user writes a status update two months ago regarding a newborn infant of the user, the status update can be stored on the user's profile page at a particular area corresponding to two months ago. If the user now decides to post a picture of his or her infant child, the picture can be posted and stored as another content item at another area of the page corresponding to the current time frame. If the user posts a video of the infant child three weeks later, the video can be stored at the user's page at a third page area corresponding to three weeks later. Under conventional approaches, the posted status update, the posted picture, and the posted video can be separate content items with no apparent or visual indication of relation among them, even though they all relate to the user's infant. Moreover, under conventional approaches, it can be challenging or tedious to locate content items not recently posted, in part because the attempt would depend on when the content items were posted, which can be difficult to remember. As such, conventional approaches can, in some cases, be uninteresting, unexpressive, or inefficient.

Therefore, it can be beneficial to provide an improved approach to organizing and presenting content. Various embodiments of the present disclosure can provide narratives based on selected content. A narrative can involve a subject, a topic, and/or a theme associated with a user of the social networking system. For example, the narrative can tell a story about the user based on content items selected to be related to the story. In some embodiments, content items associated with the user and with a particular subject, topic, and/or theme can be selected to be included in a narrative. It is contemplated that many other uses, applications, and/or variations are possible.

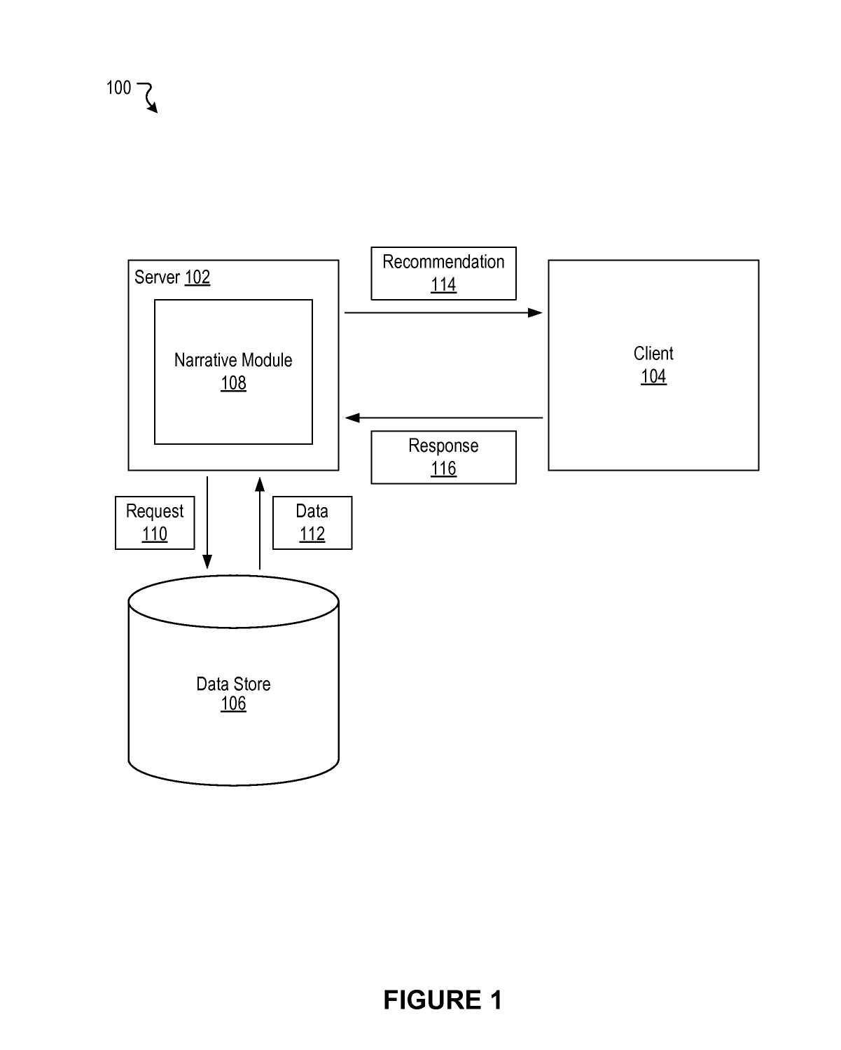

FIG. 1 illustrates an example system 100 configured to facilitate providing narratives based on selected content, according to an embodiment of the present disclosure. The example system 100 can include a server 102, a client 104, and a data store 106. As shown in the example of FIG. 1, the server 102 can also include a narrative module 108.

In some embodiments, the server 102 can be associated with a social networking system (or service). The client 104 can be associated with a user of the social networking system. For example, the client 104 can include a computing device (or system) utilized by the user of the social networking system. Moreover, the data store 106 can also be associated with the social networking system. For example, the data store 106 can be configured to store information associated with the social networking system, such as information related to the user of the social networking system.

The narrative module 108 included in the server 102 can be configured to facilitate providing narratives based on selected content. As discussed previously, a narrative can involve a particular subject, topic, and/or theme associated with the user of the social networking system. The narrative can, for example, tell a story or experience that happened to the user. The narrative can include a collection of content items selected to be related to the story or experience. Accordingly, content items associated with the user and with the particular subject, topic, and/or theme can be selected to be included in the narrative. In some cases, the narrative module 108 can be configured to select one or more content items and make a recommendation to create and post a new narrative based on the one or more selected content items. In some instances, the narrative module 108 can be configured to make a recommendation to modify an existing narrative based on the selected content items. Furthermore, in some cases, the narrative module 108 can be configured to receive one or more selected content items and to receive instructions to create a new narrative or modify an existing narrative based on the received content item selections.

In the example of FIG. 1, the narrative module 108 included in the server 102 can be configured to send a request 110 to the data store 106. In some embodiments, the request 110 can correspond to a request or query to check whether or not new content items have been posted by the user of the social networking system. If one or more new content items have been posted by the user, the data store 106 can return data 112 associated with the one or more content items. For example, the data 112 can include, but is not limited to, properties of the one or more content items, metadata associated with the one or more content items, and/or the contents included in the one or more content items.

In some implementations, the request 110 can be made in or near real-time, such as immediately in response to a system or user command. In some embodiments, the request 110 can be made at one or more specified times. In some implementations, the request 110 can be made at specified time intervals (e.g., every 24 hours).

Upon receiving (or acquiring) the data 112 associated with the one or more content items, the narrative module 108 can be configured to analyze or otherwise process the data 112. In some embodiments, based on the analysis of the data 112, the narrative module 108 can determine one or more recommendations 114 to make to the client 104. In one example, the narrative module 108 can recommend for the client 104 to create and post a narrative including the one or more content items. In another example, the narrative module 108 can recommend for the client 104 to edit, modify, or update an existing narrative to include the one or more content items. It should be appreciated that numerous variations are possible.

Upon receiving the one or more recommendations 114, the client 104 can process or otherwise handle the recommendations 114. In some embodiments, the client 104 can transmit a response 116 to the recommendations 114. In some cases, the client 104 can provide instructions in the response 116 to accept, decline, or modify the recommendations 114 or a portion thereof. For example, if the user accepts the recommendations 114, then a narrative can be created and posted, or updated based on the recommendations 114, which can result in the narrative including the one or more content items. In another example, if the user declines the recommendations 114, then the narrative will not be created, posted, or updated. In a further example, the user can modify the recommendations 114 such that the narrative will be created and posted, or updated to include other content selected by the user.

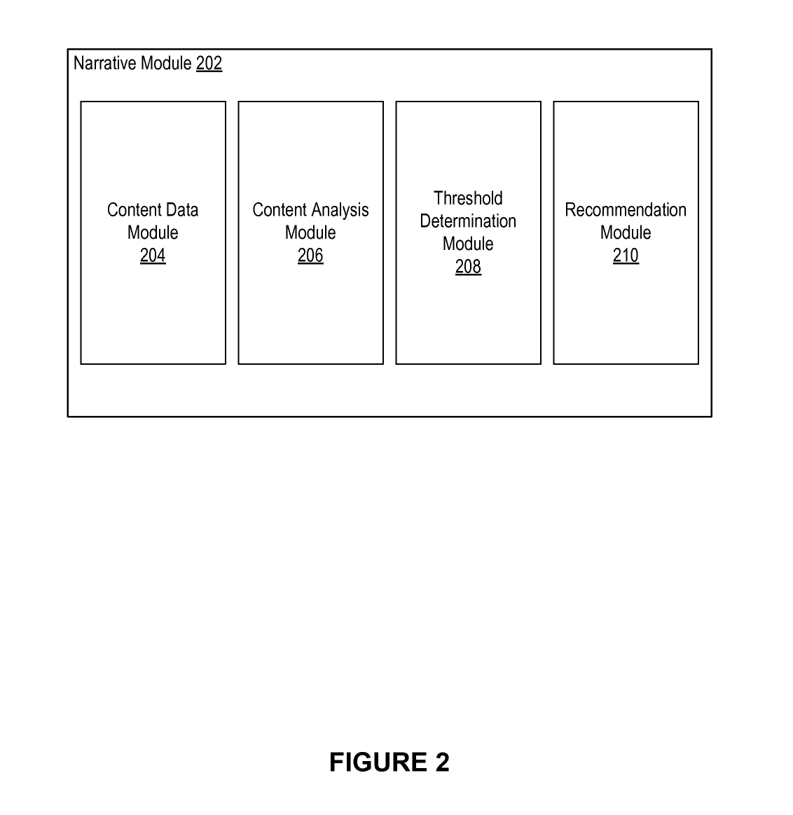

FIG. 2 illustrates an example narrative module 202 configured to facilitate providing narratives based on selected content, according to an embodiment of the present disclosure. In some embodiments, the narrative module 108 of FIG. 1 can be implemented as the example narrative module 202. As shown in FIG. 2, the example narrative module 202 can include a content data module 204, a content analysis module 206, a threshold determination module 208, and a recommendation module 210.

The content data module 204 can be configured to detect that a content item has been published. For example, the content data module 204 can check for any content items posted by a user of a social networking system that had not been posted when checked previously. When it is detected that a new content item has been published, the content data module 204 can also acquire information about the content item. The information about the content item can include, but is not limited to, the contents of the content item (e.g., data representing the content item, data included in the content item), characteristics of the content item, an author of the content item, a location or check-in related to the content item, a tag (e.g., user tag, topic tag, hashtag, location tag, a time/date tag, etc.) associated with the content item, and/or other metadata associated with the content item.

The content analysis module 206 can be configured to analyze the information about the content item. In some instances, the content analysis module 206 can determine what the content item is and/or who is associated with the content item. In one example, the content item can be determined to be a status update by the user. In another example, the content item can correspond to an image of a connection or “Friend” of the user. In a further example, the content item can include an article shared by the user. Moreover, the content analysis module 206 can determine a location, a time, and/or a date associated with the content item. Many other variations are possible.

In some embodiments, the analyzing of the information about the content item can facilitate determining a confidence metric for the content item. The confidence metric can, in some cases, indicate a likelihood that the content item is associated with a narrative. As discussed above, the narrative can involve or include at least one of a subject, a topic, or a theme associated with the user of the social networking system. In some cases the likelihood that the content item is associated with the narrative depends, at least in part, on a level of relevancy of the content item with respect to the at least one of the subject, the topic, or the theme. For example, if the subject, topic, and/or theme relates to a trip, and the location data for the posted content item indicates that the post was made at substantially the same location as the trip, then the level of relevancy can be high. This, in turn, can result in a high confidence metric for the content item. In another example, if the subject, topic, and/or theme relates to a major life event, such as a wedding, and the content item was tagged with a wedding tag (e.g., a hashtag for the wedding), then the level of relevancy and the confidence metric for the content item can be high.

Accordingly, the confidence metric for the content item and the likelihood that the content item is associated with the narrative can increase when the level of relevancy of the content item with respect to the at least one of the subject, the topic, or the theme is higher. It follows that the confidence metric for the content item and the likelihood that the content item is associated with the narrative can decrease when the level of relevancy of the content item with respect to the at least one of the subject, the topic, or the theme is lower.

Moreover, in some implementations, the at least one of the subject, the topic, or the theme can be determined based on at least one of a pattern of posts published by the user or a user command. In some cases, the user can post large amounts of content relating to a particular subject, topic, or theme. In some cases, the user can frequently post content relating to the particular subject, topic, or theme. Based on the amount and/or frequency of posts relating to the particular subject, topic, or theme, the content analysis module 206 can recognize that the particular subject, topic, or theme can form a basis for narrative creation. Furthermore, in some embodiments, the user command can specify or choose the particular subject, topic, or theme for which the narrative is to be created or generated.

Moreover, the threshold determination module 208 can determine that the confidence metric for a content item satisfies a specified threshold. In some cases, the specified threshold can correspond to a minimum level of relevancy between the content item and the particular subject, topic, or theme. When the level of relevancy of the content item with respect to the at least one of the subject, the topic, or the theme is sufficiently high, then the confidence metric for the content item can satisfy the threshold. The threshold and the level of relevancy can be variously represented as numerical, Boolean, binary, or other suitable values.

The recommendation module 210 can be configured to recommend the content item to be included in the narrative. In some implementations, the recommending of the content item to be included in the narrative can further comprise recommending a creation or posting of the narrative. The narrative can correspond to a new narrative and the narrative can include at least a portion of the content item.

It is contemplated that numerous variations can be implemented with respect to various embodiments of the present disclosure. For example, in some cases, the narrative module 202 can be configured to receive one or more user instructions to modify the narrative. Accordingly, the narrative module 202 can modify the narrative based on the one or more user instructions.

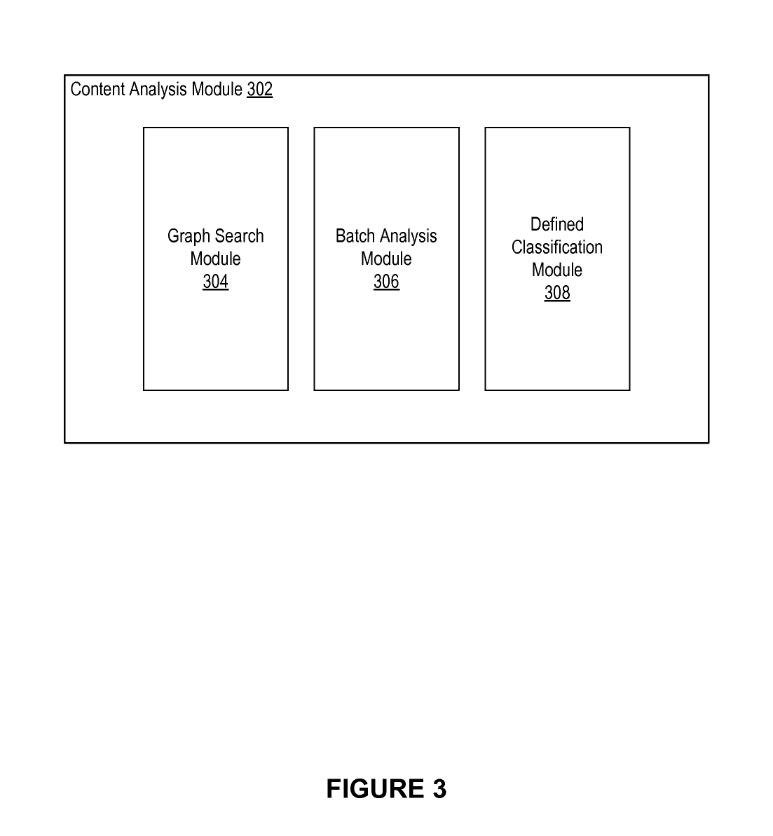

FIG. 3 illustrates an example content analysis module 302 configured to facilitate providing narratives based on selected content, according to an embodiment of the present disclosure. In some embodiments, the content analysis module 206 of FIG. 2 can be implemented as the example content analysis module 302. As shown in FIG. 3, the example content analysis module 302 can include a graph search module 304, a batch analysis module 306, and a defined classification module 308.

In some embodiments, a content item can correspond to a node in a graph infrastructure associated with a user of a social networking system. In some instances, information about the content item can be acquired by performing a search of the graph infrastructure. The graph search module 304 can be configured to facilitate performing the search of the graph infrastructure to acquire the information about the content item. As such, in some embodiments, at least a portion or instance of the graph search module 304 can be implemented in, can reside with, and/or can operate in conjunction with the content data module 204 of FIG. 2.

Furthermore, in some cases, the graph search module 304 can facilitate analyzing the information about the content item to determine a confidence metric for the content item. In one example, if a subject (e.g., subject matter, topic, theme, etc.) for a narrative is selected or determined to involve a set of connections or “Friends” of the user within a particular time range, then the graph search module 304 can query a data store (e.g., data store 106 in FIG. 1) of the social networking system to identify all content items associated with the set of connections and with the particular time range. In this example, since the identified content items are associated with the set of connections and with the particular time range, the content items can have sufficiently high levels of relevance and the confidence metrics for the content items can satisfy the threshold. Many other examples are also possible.

In some implementations, the batch analysis module 306 can be configured to perform batch processing with respect to a data warehouse (e.g., data store 106 in FIG. 1) of the social networking system in order to acquire the information about the content item from the data warehouse. Accordingly, in some cases, at least a portion or instance of the batch analysis module 306 can be implemented in, can reside with, and/or can operate in conjunction with the content data module 204 of FIG. 2. The batch processing can be performed, for example, at specified time internals (e.g., every 24 hours). Moreover, similar to the graph search module 304, the batch analysis module 306 can also identify content items that have sufficiently high levels of relevance such that the confidence metrics for the content items satisfy the threshold.

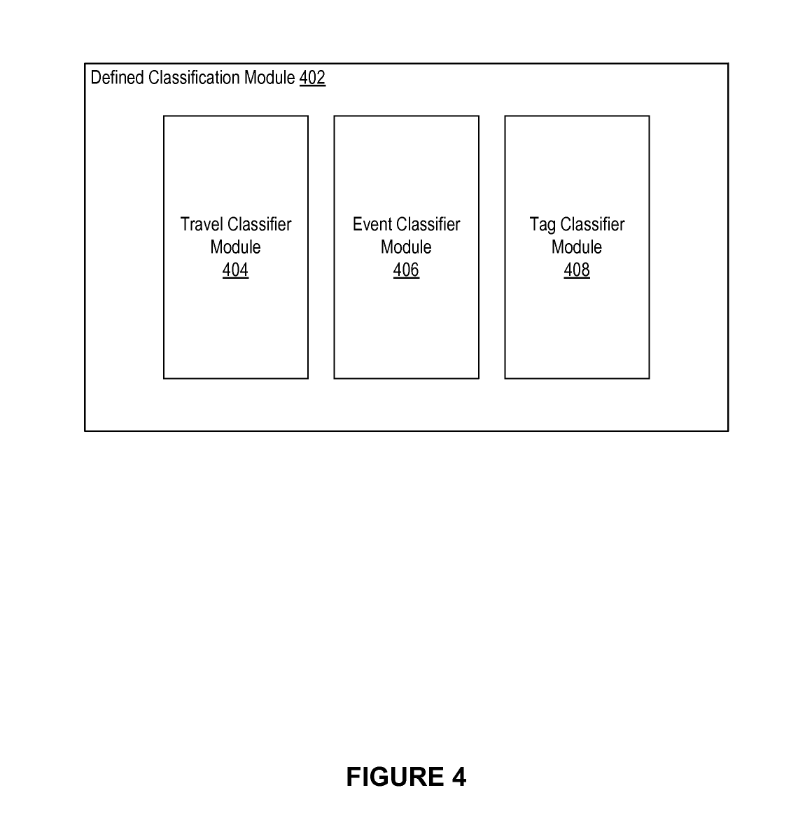

The defined classification module 308 can be configured to analyze the information about the content item to determine that the content item is associated with one or more defined classifiers. In some cases, the confidence metric for the content item can be determined based on the one or more defined classifiers. The defined classification module 308 will be discussed in more detail below with reference to FIG. 4.

FIG. 4 illustrates an example defined classification module 402 configured to facilitate providing narratives based on selected content, according to an embodiment of the present disclosure. In some embodiments, the defined classification module 308 of FIG. 3 can be implemented as the example defined classification module 402. As shown in FIG. 4, the example defined classification module 402 can include a travel classifier module 404, an event classifier module 406, and a tag classifier module 408.

As discussed previously, the defined classification module 402 can be configured to analyze information about a content item to determine that the content item is associated with one or more defined classifiers. The one or more defined classifiers can include, but is not limited to, at least one of a travel classifier, an event classifier, or a tag classifier. Moreover, in some cases, the confidence metric can be determined (or generated, calculated, etc.) based on the one or more defined classifiers.

In one example, if a particular subject (or topic, theme, etc.) has been selected or determined for a narrative to involve travelling, then the travel classifier module 404 can be configured to analyze the information about a content item to determine whether the content item is associated with particular travel. In some implementations, the travel classifier module 404 can utilize location data and/or check-in data associated with the content item. If, for example, the particular subject relates to a tour in Paris, France and the location data and/or check-in data indicates that the content item is posted in or substantially near Paris, France, then the travel classifier module 404 can determine that the content item relates to travel in Paris, France. Further, the travel classifier module 404 can generate a confidence metric for the content item that satisfies the threshold.

In another example, if the particular subject has been selected or determined to involve an event such as a major life event, then the event classifier module 406 can be configured to analyze the information about a content item to determine whether the content item is associated with a particular event. In some embodiments, the event classifier module 406 can utilize event data to determine whether the content item is associated with an event and, if so, which event. If, for example, the particular subject relates to an engagement, and the event data indicates that the content item is associated with the engagement, then the event classifier module 406 can determine or generate a confidence metric for the content item that satisfies the threshold.

In a further example, if the particular subject involves a topic of interest tagged by the user, then the tag classifier module 408 can be configured to analyze the information about the content item to determine whether the content item is associated with a particular tag. In some embodiments, the tag classifier module 408 can utilize tag data to determine whether the content item is associated with the topic of interest tagged by the user. If, for example, the particular subject relates to a tag such as #30thbirthday, and the content item is tagged with #30thbirthday, then the tag classifier module 408 can determine that the content item relates to the tag. Further, the tag classifier module 408 can generate a confidence metric for the content item that satisfies the threshold.

In some embodiments, the classification analysis performed on content items by the defined classification module 402 to determine their potential relevance with a particular subject, topic, and/or theme associated with a narrative can be based on myriad techniques. Content items constituting or including images or text may be analyzed and classified based on any suitable processing technique. For example, an image classification technique may gather contextual cues for a sample set of images and use the contextual cues to generate a training set of images. The training set of images may be used to train a classifier to generate visual pattern templates of an image class. The classifier may score an evaluation set of images based on correlation with the visual pattern templates. The highest scoring images of the evaluation set of images may be deemed to be mostly closely related to the image class. As another example, a hint detection technique can include natural language processing (NLP) to assist in identifying hints in comments associated with an image. The NLP-based hint detection technique may identify, based at least in part on natural language processing, one or more tokens in a comment that may assist in determining the subject matter of an image. Other suitable techniques are possible.

It is further contemplated that there can be many other uses, applications, and/or variations associated with the various embodiments of the present disclosure.

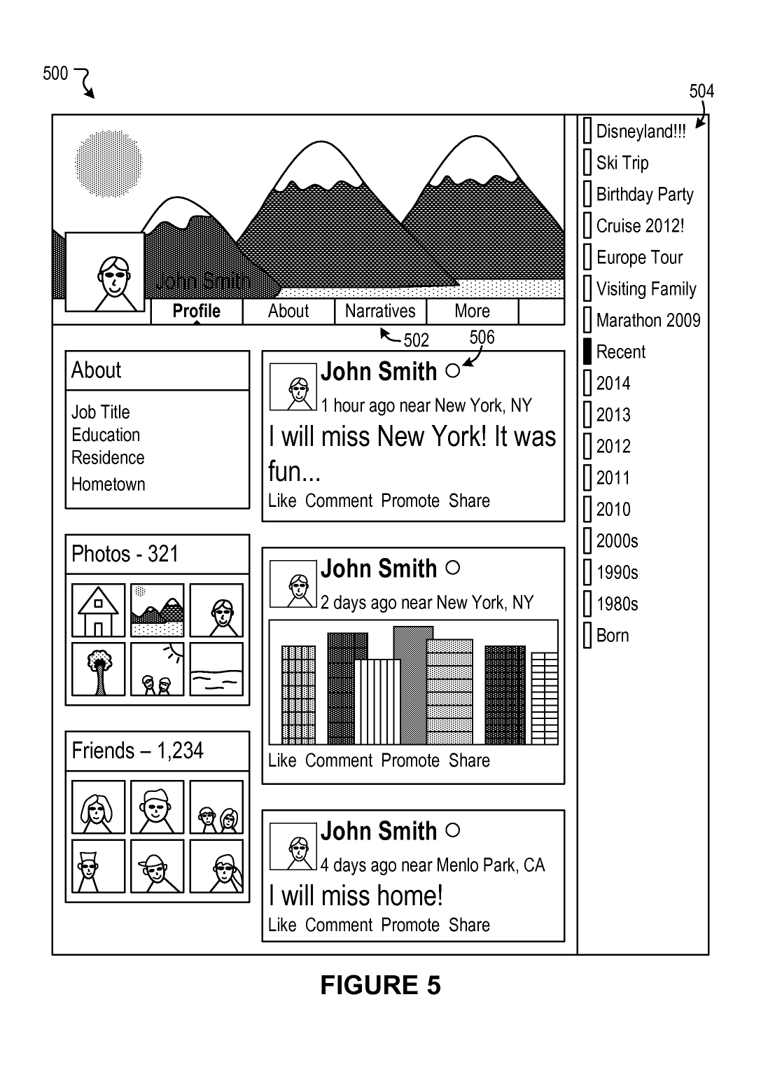

FIG. 5 illustrates an example screenshot 500 associated with providing narratives based on selected content, according to an embodiment of the present disclosure. The example screenshot 500 can include a profile page or a timeline of a user identified as “John Smith”. In some instances, the profile page can include an interactive element such as a clickable tab (e.g., “Narratives” tab 502) to access a set of narratives associated with John Smith. Moreover, in some implementations, each narrative in the set of narratives can be accessible via a chronological interface 504. In the example of FIG. 5, each text line or title above “Recent” in the interface 504 can be clickable to access a respective narrative associated with John Smith.

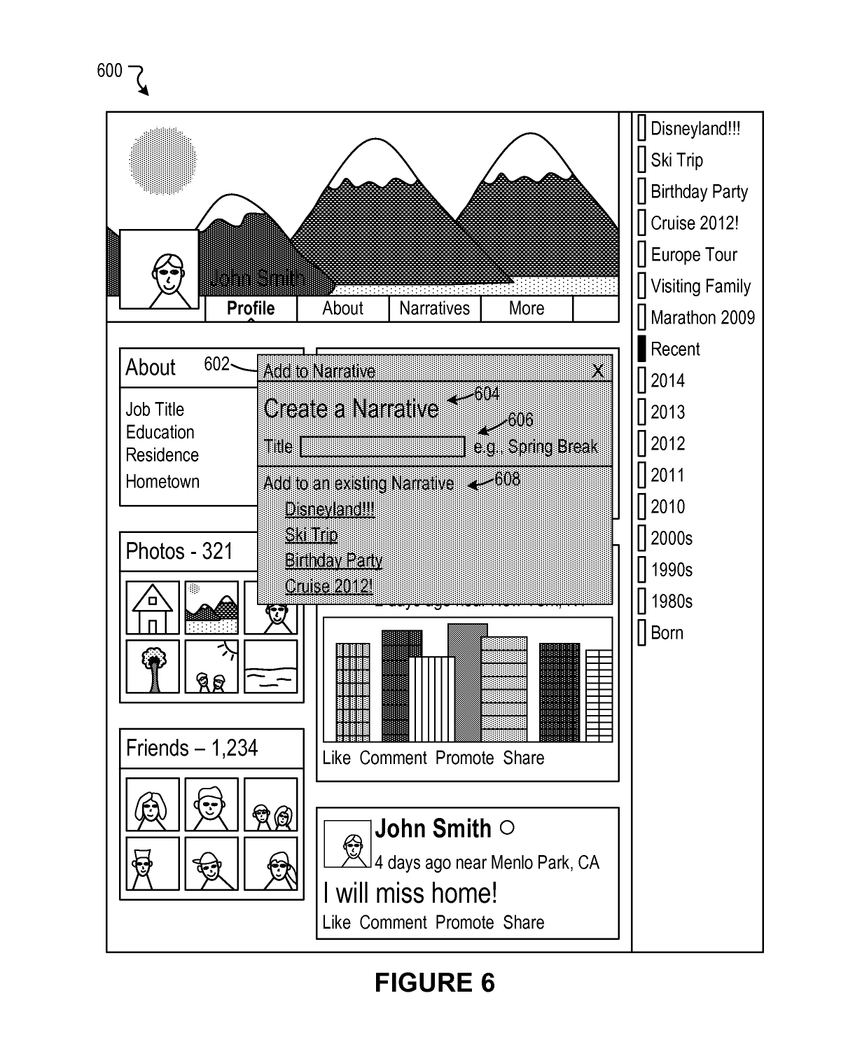

Further, in some embodiments, a narrative creation/modification element can be provided with each content item posted by John Smith. In FIG. 5, there can be a narrative creation/modification element (e.g., button 506) for the most recent post by John Smith stating “I will miss New York! It was fun . . . ” If John Smith clicks on the button 506, he can be presented with an option(s) to create or modify a narrative using this most recent post. More details will be discussed below with reference to FIG. 6.

Although not explicitly illustrated, in some embodiments, there can be an system generated recommendation for John Smith to create a narrative based on content items determined to have a sufficient level of relevance, as discussed above. In one example, when John Smith visits his profile page every N^{th} (e.g., 10^{th}) time, the disclosed technology can check whether a recommendation for narrative creation/modification should be made.

FIG. 6 illustrates an example screenshot 600 associated with providing narratives based on selected content, according to an embodiment of the present disclosure. The example screenshot 600 illustrates the screenshot 500 of FIG. 5 subsequent to the button 506 being clicked, which causes a narrative creation/modification interface 602 to be presented.

As shown in the example of FIG. 6, the narrative creation/modification interface 602 can enable John Smith to include the most recent post in a newly created narrative 604 with a new title 606 or to include the most recent post as a modification to an existing narrative 608.

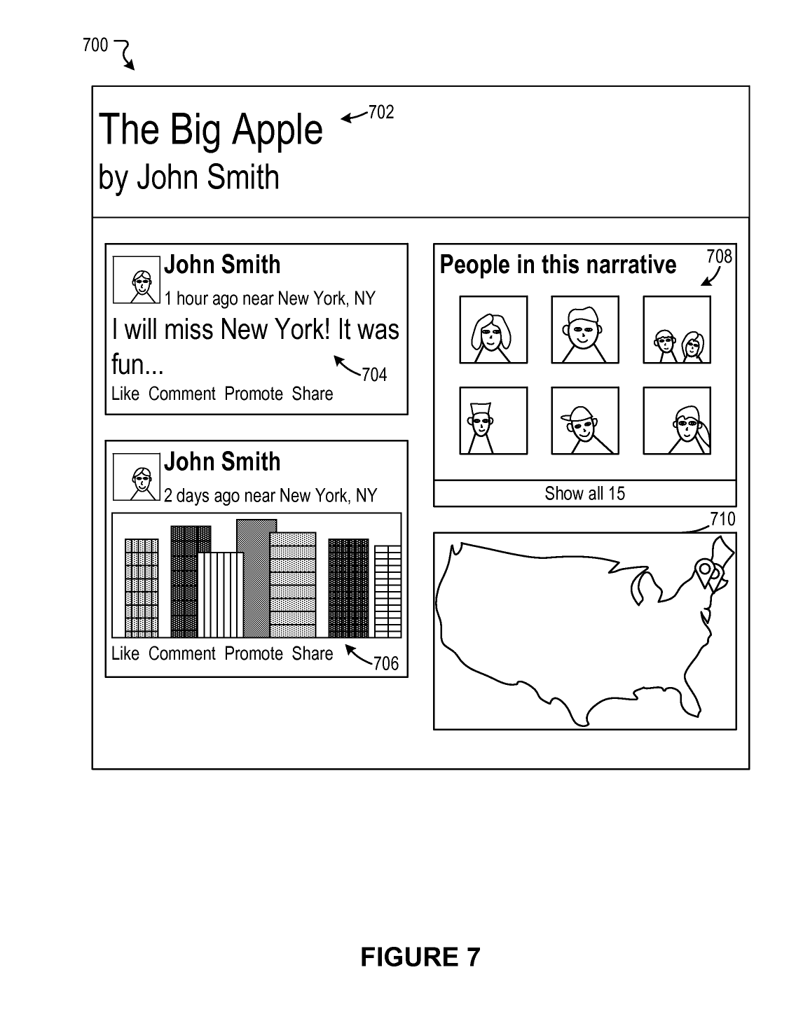

FIG. 7 illustrates an example screenshot 700 associated with providing narratives based on selected content, according to an embodiment of the present disclosure. The screenshot 700 illustrates an example depiction of how a narrative can be presented. As discussed above, the narrative can involve a subject, a topic, and/or a theme associated with a user of the social networking system. The narrative can tell a story about the user based on content items determined or selected to be related to the story. The content items included in the narrative can be associated with the user and with the particular subject, topic, and/or theme of the narrative.

In FIG. 7, the example narrative is associated with John Smith and is titled “The Big Apple” 702. The particular subject of the narrative corresponds to John Smith's recent trip to New York. As shown, the narrative can include a collection of various content items relevant to John Smith's recent trip to New York. In this example, the narrative includes a status post 704 made during the trip, a picture 706 taken during the trip, and connections or “Friends” 708 of John Smith who are associated with his New York trip (e.g., tagged in pictures, tagged in notes, checked-in together, etc.). Further, although the content items in this example narrative are posted by John Smith, content items made by other users can also be included in this narrative as long as they are sufficiently relevant (e.g., other users' pictures of John Smith during this trip). Moreover, no content item may be published in a narrative except in accordance with applicable privacy settings.

Furthermore, in some implementations, a map 710 showing locations associated with the content items in the narrative can be presented. For example, if different content items in the narrative were posted at different locations, the map can show the different locations.

It is further contemplated that there can be many other uses, applications, and/or variations associated with the various embodiments of the present disclosure.

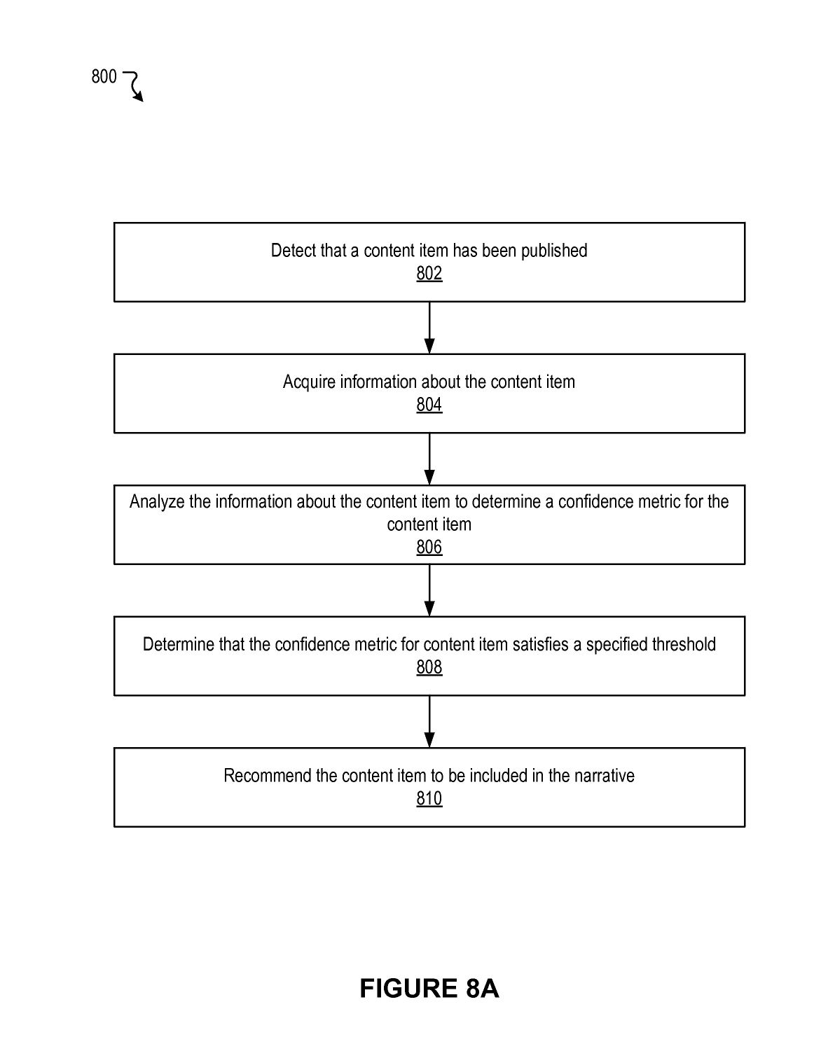

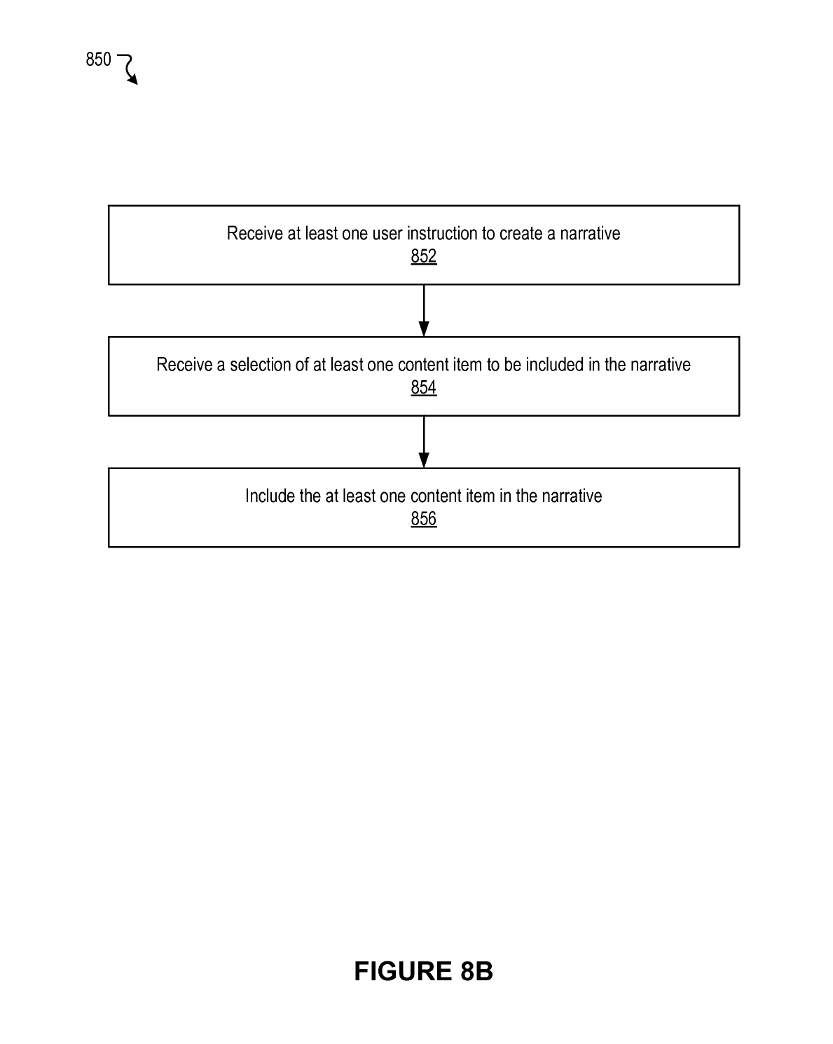

FIG. 8A illustrates an example method 800 associated with providing narratives based on selected content, according to an embodiment of the present disclosure. It should be appreciated that there can be additional, fewer, or alternative steps performed in similar or alternative orders, or in parallel, within the scope of the various embodiments unless otherwise stated.

At block 802, the example method 800 can detect that a content item has been published. For example, it can be detected that the content item was published recently (e.g., within a specified time period) via a social networking system by a user of the social networking system. The content item can, for example, be newly published.

At block 804, the example method 800 can acquire information about the content item. For example, one or more authors, locations, tags, topics, and/or other metadata associated with the content item can be acquired, received, or obtained.

At block 806, the example method 800 can analyze the information about the content item to determine a confidence metric for the content item. In some embodiments, the confidence metric can indicate a likelihood that the content item is associated with a narrative.

At block 808, the example method 800 can determine that the confidence metric for content item satisfies a specified threshold. For example, the method 600 can determine that the likelihood of the content item being associated with the narrative is sufficiently high based on the analysis of the information about the content item.

At block 810, the example method 800 can recommend the content item to be included in the narrative. In one example, the narrative can correspond to a new narrative in which the content item is to be included. In another example, the narrative can correspond to an existing narrative that is to be updated by including the content item.

In some embodiments, when the narrative corresponds to an existing narratives, the existing narrative can be created prior to detecting that the content item has been published. In some implementations, the narrative can be created based on at least one user instruction to create the narrative. Furthermore, in some embodiments, a selection of at least one other content item to be included in the narrative can be received prior to detecting that the content item has been published. The at least one other content item can be included in the narrative.

In some embodiments, the narrative can be associated with a first user of a social networking system. In some cases, the content item can be published by at least one of the first user or a second user of the social networking system. In some instances, the narrative including at least the content item can be presented at a profile associated with the first user of the social networking system. In some implementations, the presenting of the narrative including the content item can further comprise presenting at least one of a map indicating a set of locations associated with the narrative. In some embodiments, at least one other narrative associated with the first user can be presented. In some cases, at least one of an interface section or an interactive timeline from which the narrative and the at least one other narrative are accessible can be presented.

FIG. 8B illustrates an example method 850 associated with providing narratives based on selected content, according to an embodiment of the present disclosure. Again, it should be appreciated that there can be additional, fewer, or alternative steps performed in similar or alternative orders, or in parallel, within the scope of the various embodiments unless otherwise stated.

At block 852, the example method 850 can receive at least one user instruction to create a narrative, such as a new narrative. In response, the narrative can be created based on the at least one user instruction. A content item may already be associated with the narrative.

At block 854, the example method 850 can receive a selection of at least one other content item to be included in the narrative. In some embodiments, the selection can be received prior to detection that the content item has been published. In some embodiments, the selection can correspond to a user selection. In some embodiments, the selection can correspond to a system selection.

At block 856, the example method 850 can include the at least one other content item in the narrative. For example, if the narrative is presented or published, the content item and the at least one other content item included in the narrative can be presented or published as well.

Again, it is contemplated that there can be many other uses, applications, and/or variations associated with the various embodiments of the present disclosure. For example, in some embodiments, the disclosed technology can learn, improve, and/or be refined over time.

### Social Networking System—Example Implementation

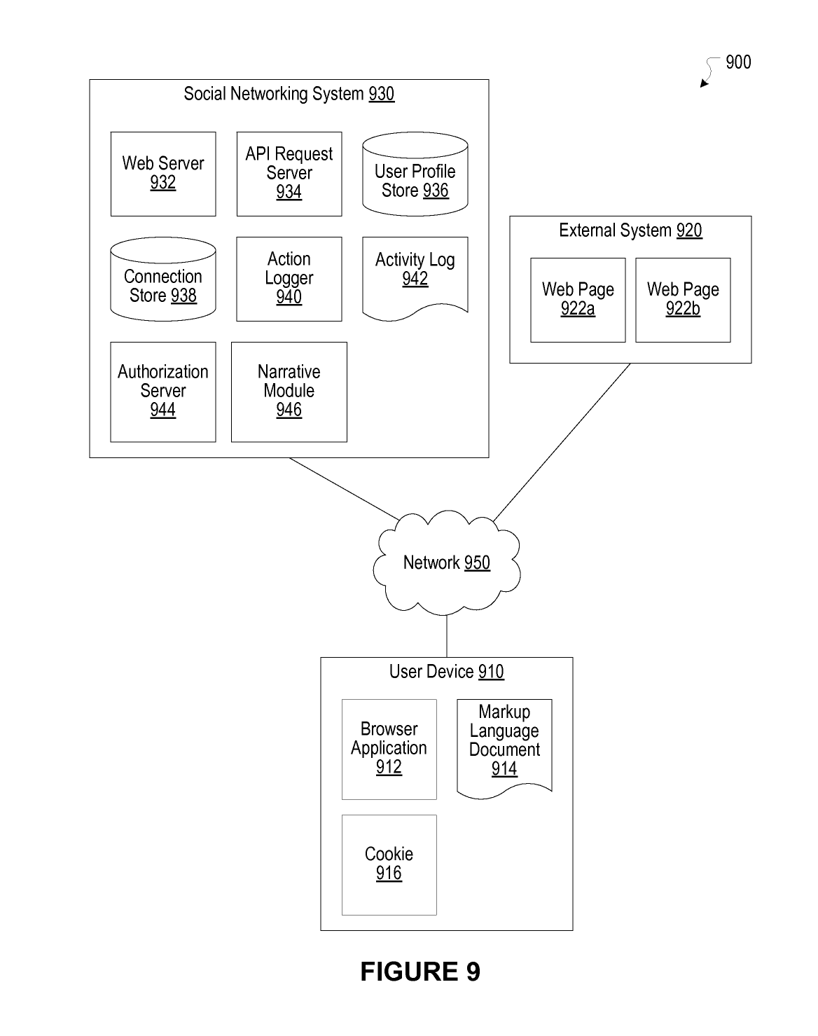

FIG. 9 illustrates a network diagram of an example system 900 that can be utilized in various scenarios, in accordance with an embodiment of the present disclosure. The system 900 includes one or more user devices 910, one or more external systems 920, a social networking system (or service) 930, and a network 950. In an embodiment, the social networking service, provider, and/or system discussed in connection with the embodiments described above may be implemented as the social networking system 930. For purposes of illustration, the embodiment of the system 900, shown by FIG. 9, includes a single external system 920 and a single user device 910. However, in other embodiments, the system 900 may include more user devices 910 and/or more external systems 920. In certain embodiments, the social networking system 930 is operated by a social network provider, whereas the external systems 920 are separate from the social networking system 930 in that they may be operated by different entities. In various embodiments, however, the social networking system 930 and the external systems 920 operate in conjunction to provide social networking services to users (or members) of the social networking system 930. In this sense, the social networking system 930 provides a platform or backbone, which other systems, such as external systems 920, may use to provide social networking services and functionalities to users across the Internet.

The user device 910 comprises one or more computing devices that can receive input from a user and transmit and receive data via the network 950. In one embodiment, the user device 910 is a conventional computer system executing, for example, a Microsoft Windows compatible operating system (OS), Apple OS X, and/or a Linux distribution. In another embodiment, the user device 910 can be a device having computer functionality, such as a smart-phone, a tablet, a personal digital assistant (PDA), a mobile telephone, etc. The user device 910 is configured to communicate via the network 950. The user device 910 can execute an application, for example, a browser application that allows a user of the user device 910 to interact with the social networking system 930. In another embodiment, the user device 910 interacts with the social networking system 930 through an application programming interface (API) provided by the native operating system of the user device 910, such as iOS and ANDROID. The user device 910 is configured to communicate with the external system 920 and the social networking system 930 via the network 950, which may comprise any combination of local area and/or wide area networks, using wired and/or wireless communication systems.

In one embodiment, the network 950 uses standard communications technologies and protocols. Thus, the network 950 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 950 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 950 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 910 may display content from the external system 920 and/or from the social networking system 930 by processing a markup language document 914 received from the external system 920 and from the social networking system 930 using a browser application 912. The markup language document 914 identifies content and one or more instructions describing formatting or presentation of the content. By executing the instructions included in the markup language document 914, the browser application 912 displays the identified content using the format or presentation described by the markup language document 914. For example, the markup language document 914 includes instructions for generating and displaying a web page having multiple frames that include text and/or image data retrieved from the external system 920 and the social networking system 930. In various embodiments, the markup language document 914 comprises a data file including extensible markup language (XML) data, extensible hypertext markup language (XHTML) data, or other markup language data. Additionally, the markup language document 914 may include JavaScript Object Notation (JSON) data, JSON with padding (JSONP), and JavaScript data to facilitate data-interchange between the external system 920 and the user device 910. The browser application 912 on the user device 910 may use a JavaScript compiler to decode the markup language document 914.

The markup language document 914 may also include, or link to, applications or application frameworks such as FLASH™ or Unity™ applications, the SilverLight™ application framework, etc.

In one embodiment, the user device 910 also includes one or more cookies 916 including data indicating whether a user of the user device 910 is logged into the social networking system 930, which may enable modification of the data communicated from the social networking system 930 to the user device 910.

The external system 920 includes one or more web servers that include one or more web pages 922a, 922b, which are communicated to the user device 910 using the network 950. The external system 920 is separate from the social networking system 930. For example, the external system 920 is associated with a first domain, while the social networking system 930 is associated with a separate social networking domain. Web pages 922a, 922b, included in the external system 920, comprise markup language documents 914 identifying content and including instructions specifying formatting or presentation of the identified content.

The social networking system 930 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 930 may be administered, managed, or controlled by an operator. The operator of the social networking system 930 may be a human being, an automated application, or a series of applications for managing content, regulating policies, and collecting usage metrics within the social networking system 930. Any type of operator may be used.

Users may join the social networking system 930 and then add connections to any number of other users of the social networking system 930 to whom they desire to be connected. As used herein, the term “friend” refers to any other user of the social networking system 930 to whom a user has formed a connection, association, or relationship via the social networking system 930. For example, in an embodiment, if users in the social networking system 930 are represented as nodes in the social graph, the term “friend” can refer to an edge formed between and directly connecting two user nodes.

Connections may be added explicitly by a user or may be automatically created by the social networking system 930 based on common characteristics of the users (e.g., users who are alumni of the same educational institution). For example, a first user specifically selects a particular other user to be a friend. Connections in the social networking system 930 are usually in both directions, but need not be, so the terms “user” and “friend” depend on the frame of reference. Connections between users of the social networking system 930 are usually bilateral (“two-way”), or “mutual,” but connections may also be unilateral, or “one-way.” For example, if Bob and Joe are both users of the social networking system 930 and connected to each other, Bob and Joe are each other's connections. If, on the other hand, Bob wishes to connect to Joe to view data communicated to the social networking system 930 by Joe, but Joe does not wish to form a mutual connection, a unilateral connection may be established. The connection between users may be a direct connection; however, some embodiments of the social networking system 930 allow the connection to be indirect via one or more levels of connections or degrees of separation.

In addition to establishing and maintaining connections between users and allowing interactions between users, the social networking system 930 provides users with the ability to take actions on various types of items supported by the social networking system 930. These items may include groups or networks (i.e., social networks of people, entities, and concepts) to which users of the social networking system 930 may belong, events or calendar entries in which a user might be interested, computer-based applications that a user may use via the social networking system 930, transactions that allow users to buy or sell items via services provided by or through the social networking system 930, and interactions with advertisements that a user may perform on or off the social networking system 930. These are just a few examples of the items upon which a user may act on the social networking system 930, and many others are possible. A user may interact with anything that is capable of being represented in the social networking system 930 or in the external system 920, separate from the social networking system 930, or coupled to the social networking system 930 via the network 950.

The social networking system 930 is also capable of linking a variety of entities. For example, the social networking system 930 enables users to interact with each other as well as external systems 920 or other entities through an API, a web service, or other communication channels. The social networking system 930 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 930. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 930 modifies edges connecting the various nodes to reflect the relationships and interactions.

The social networking system 930 also includes user-generated content, which enhances a user's interactions with the social networking system 930. User-generated content may include anything a user can add, upload, send, or “post” to the social networking system 930. For example, a user communicates posts to the social networking system 930 from a user device 910. Posts may include data such as status updates or other textual data, location information, images such as photos, videos, links, music or other similar data and/or media. Content may also be added to the social networking system 930 by a third party. Content “items” are represented as objects in the social networking system 930. In this way, users of the social networking system 930 are encouraged to communicate with each other by posting text and content items of various types of media through various communication channels. Such communication increases the interaction of users with each other and increases the frequency with which users interact with the social networking system 930.

The social networking system 930 includes a web server 932, an API request server 934, a user profile store 936, a connection store 938, an action logger 940, an activity log 942, and an authorization server 944. In an embodiment of the invention, the social networking system 930 may include additional, fewer, or different components for various applications. Other components, such as network interfaces, security mechanisms, load balancers, failover servers, management and network operations consoles, and the like are not shown so as to not obscure the details of the system.

The user profile store 936 maintains information about user accounts, including biographic, demographic, and other types of descriptive information, such as work experience, educational history, hobbies or preferences, location, and the like that has been declared by users or inferred by the social networking system 930. This information is stored in the user profile store 936 such that each user is uniquely identified. The social networking system 930 also stores data describing one or more connections between different users in the connection store 938. The connection information may indicate users who have similar or common work experience, group memberships, hobbies, or educational history. Additionally, the social networking system 930 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 930, such as non-person entities, buckets, cluster centers, images, interests, pages, external systems, concepts, and the like are also stored in the connection store 938.

The social networking system 930 maintains data about objects with which a user may interact. To maintain this data, the user profile store 936 and the connection store 938 store instances of the corresponding type of objects maintained by the social networking system 930. Each object type has information fields that are suitable for storing information appropriate to the type of object. For example, the user profile store 936 contains data structures with fields suitable for describing a user's account and information related to a user's account. When a new object of a particular type is created, the social networking system 930 initializes a new data structure of the corresponding type, assigns a unique object identifier to it, and begins to add data to the object as needed. This might occur, for example, when a user becomes a user of the social networking system 930, the social networking system 930 generates a new instance of a user profile in the user profile store 936, assigns a unique identifier to the user account, and begins to populate the fields of the user account with information provided by the user.

The connection store 938 includes data structures suitable for describing a user's connections to other users, connections to external systems 920 or connections to other entities. The connection store 938 may also associate a connection type with a user's connections, which may be used in conjunction with the user's privacy setting to regulate access to information about the user. In an embodiment of the invention, the user profile store 936 and the connection store 938 may be implemented as a federated database.

Data stored in the connection store 938, the user profile store 936, and the activity log 942 enables the social networking system 930 to generate the social graph that uses nodes to identify various objects and edges connecting nodes to identify relationships between different objects. For example, if a first user establishes a connection with a second user in the social networking system 930, user accounts of the first user and the second user from the user profile store 936 may act as nodes in the social graph. The connection between the first user and the second user stored by the connection store 938 is an edge between the nodes associated with the first user and the second user. Continuing this example, the second user may then send the first user a message within the social networking system 930. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 930 (or, alternatively, in an image maintained by another system outside of the social networking system 930). The image may itself be represented as a node in the social networking system 930. This tagging action may create edges between the first user and the second user as well as create an edge between each of the users and the image, which is also a node in the social graph. In yet another example, if a user confirms attending an event, the user and the event are nodes obtained from the user profile store 936, where the attendance of the event is an edge between the nodes that may be retrieved from the activity log 942. By generating and maintaining the social graph, the social networking system 930 includes data describing many different types of objects and the interactions and connections among those objects, providing a rich source of socially relevant information.

The web server 932 links the social networking system 930 to one or more user devices 910 and/or one or more external systems 920 via the network 950. The web server 932 serves web pages, as well as other web-related content, such as Java, JavaScript, Flash, XML, and so forth. The web server 932 may include a mail server or other messaging functionality for receiving and routing messages between the social networking system 930 and one or more user devices 910. The messages can be instant messages, queued messages (e.g., email), text and SMS messages, or any other suitable messaging format.

The API request server 934 allows one or more external systems 920 and user devices 910 to call access information from the social networking system 930 by calling one or more API functions. The API request server 934 may also allow external systems 920 to send information to the social networking system 930 by calling APIs. The external system 920, in one embodiment, sends an API request to the social networking system 930 via the network 950, and the API request server 934 receives the API request. The API request server 934 processes the request by calling an API associated with the API request to generate an appropriate response, which the API request server 934 communicates to the external system 920 via the network 950. For example, responsive to an API request, the API request server 934 collects data associated with a user, such as the user's connections that have logged into the external system 920, and communicates the collected data to the external system 920. In another embodiment, the user device 910 communicates with the social networking system 930 via APIs in the same manner as external systems 920.

The action logger 940 is capable of receiving communications from the web server 932 about user actions on and/or off the social networking system 930. The action logger 940 populates the activity log 942 with information about user actions, enabling the social networking system 930 to discover various actions taken by its users within the social networking system 930 and outside of the social networking system 930. Any action that a particular user takes with respect to another node on the social networking system 930 may be associated with each user's account, through information maintained in the activity log 942 or in a similar database or other data repository. Examples of actions taken by a user within the social networking system 930 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 930, the action is recorded in the activity log 942. In one embodiment, the social networking system 930 maintains the activity log 942 as a database of entries. When an action is taken within the social networking system 930, an entry for the action is added to the activity log 942. The activity log 942 may be referred to as an action log.

Additionally, user actions may be associated with concepts and actions that occur within an entity outside of the social networking system 930, such as an external system 920 that is separate from the social networking system 930. For example, the action logger 940 may receive data describing a user's interaction with an external system 920 from the web server 932. In this example, the external system 920 reports a user's interaction according to structured actions and objects in the social graph.

Other examples of actions where a user interacts with an external system 920 include a user expressing an interest in an external system 920 or another entity, a user posting a comment to the social networking system 930 that discusses an external system 920 or a web page 922a within the external system 920, a user posting to the social networking system 930 a Uniform Resource Locator (URL) or other identifier associated with an external system 920, a user attending an event associated with an external system 920, or any other action by a user that is related to an external system 920. Thus, the activity log 942 may include actions describing interactions between a user of the social networking system 930 and an external system 920 that is separate from the social networking system 930.

The authorization server 944 enforces one or more privacy settings of the users of the social networking system 930. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 920, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 920. One embodiment allows the specification of the set of entities to comprise an enumeration of entities. For example, the user may provide a list of external systems 920 that are allowed to access certain information. Another embodiment allows the specification to comprise a set of entities along with exceptions that are not allowed to access the information. For example, a user may allow all external systems 920 to access the user's work information, but specify a list of external systems 920 that are not allowed to access the work information. Certain embodiments call the list of exceptions that are not allowed to access certain information a “block list”. External systems 920 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 944 contains logic to determine if certain information associated with a user can be accessed by a user's friends, external systems 920, and/or other applications and entities. The external system 920 may need authorization from the authorization server 944 to access the user's more private and sensitive information, such as the user's work phone number. Based on the user's privacy settings, the authorization server 944 determines if another user, the external system 920, an application, or another entity is allowed to access information associated with the user, including information about actions taken by the user.

In some embodiments, the social networking system 930 can include a narrative module 946. The narrative module 946 can, for example, be implemented as the narrative module 108 of FIG. 1 and/or the narrative module 202 of FIG. 2. The narrative module 946 can be configured to detect that a content item has been published. In some embodiments, information about the content item can be acquired. The narrative module 946 can be configured to analyze the information about the content item to determine a confidence metric for the content item. In some cases, the confidence metric can indicate a likelihood that the content item is associated with a narrative. The narrative module 946 can also be configured to determine that the confidence metric for content item satisfies a specified threshold. Further, the narrative module 946 can be configured to recommend the content item to be included in the narrative. It is understood that many variations are possible.

### Hardware Implementation

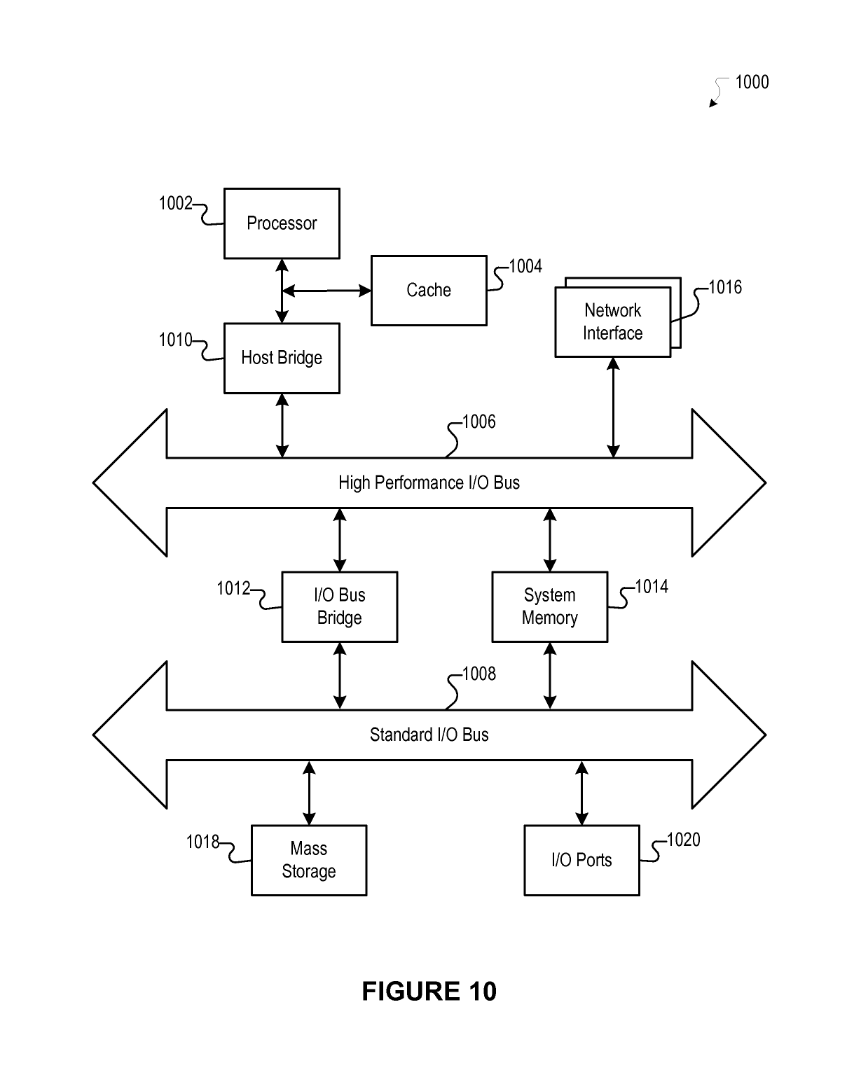

The foregoing processes and features can be implemented by a wide variety of machine and computer system architectures and in a wide variety of network and computing environments. FIG. 10 illustrates an example of a computer system 1000 that may be used to implement one or more of the embodiments described herein in accordance with an embodiment of the invention. The computer system 1000 includes sets of instructions for causing the computer system 1000 to perform the processes and features discussed herein. The computer system 1000 may be connected (e.g., networked) to other machines. In a networked deployment, the computer system 1000 may operate in the capacity of a server machine or a client machine in a client-server network environment, or as a peer machine in a peer-to-peer (or distributed) network environment. In an embodiment of the invention, the computer system 1000 may be the social networking system 930, the user device 910, and the external system 1020, or a component thereof. In an embodiment of the invention, the computer system 1000 may be one server among many that constitutes all or part of the social networking system 930.

The computer system 1000 includes a processor 1002, a cache 1004, and one or more executable modules and drivers, stored on a computer-readable medium, directed to the processes and features described herein. Additionally, the computer system 1000 includes a high performance input/output (I/O) bus 1006 and a standard I/O bus 1008. A host bridge 1010 couples processor 1002 to high performance I/O bus 1006, whereas I/O bus bridge 1012 couples the two buses 1006 and 1008 to each other. A system memory 1014 and one or more network interfaces 1016 couple to high performance I/O bus 1006. The computer system 1000 may further include video memory and a display device coupled to the video memory (not shown). Mass storage 1018 and I/O ports 1020 couple to the standard I/O bus 1008. The computer system 1000 may optionally include a keyboard and pointing device, a display device, or other input/output devices (not shown) coupled to the standard I/O bus 1008. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 1000 are described in greater detail below. In particular, the network interface 1016 provides communication between the computer system 1000 and any of a wide range of networks, such as an Ethernet (e.g., IEEE 802.3) network, a backplane, etc. The mass storage 1018 provides permanent storage for the data and programming instructions to perform the above-described processes and features implemented by the respective computing systems identified above, whereas the system memory 1014 (e.g., DRAM) provides temporary storage for the data and programming instructions when executed by the processor 1002. The I/O ports 1020 may be one or more serial and/or parallel communication ports that provide communication between additional peripheral devices, which may be coupled to the computer system 1000.

The computer system 1000 may include a variety of system architectures, and various components of the computer system 1000 may be rearranged. For example, the cache 1004 may be on-chip with processor 1002. Alternatively, the cache 1004 and the processor 1002 may be packed together as a “processor module”, with processor 1002 being referred to as the “processor core”. Furthermore, certain embodiments of the invention may neither require nor include all of the above components. For example, peripheral devices coupled to the standard I/O bus 1008 may couple to the high performance I/O bus 1006. In addition, in some embodiments, only a single bus may exist, with the components of the computer system 1000 being coupled to the single bus. Moreover, the computer system 1000 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 1000 that, when read and executed by one or more processors, cause the computer system 1000 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 1000, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 1002. Initially, the series of instructions may be stored on a storage device, such as the mass storage 1018. However, the series of instructions can be stored on any suitable computer readable storage medium. Furthermore, the series of instructions need not be stored locally, and could be received from a remote storage device, such as a server on a network, via the network interface 1016. The instructions are copied from the storage device, such as the mass storage 1018, into the system memory 1014 and then accessed and executed by the processor 1002. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 1000 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
detecting, by a computing system, that a content item has been published;
acquiring, by the computing system, information about the content item;
analyzing, by the computing system, the information about the content item to determine a confidence metric for the content item, the confidence metric indicating a likelihood that the content item is associated with a narrative;
determining, by the computing system, that the confidence metric for content item satisfies a specified threshold; and
recommending, by the computing system, the content item to be included in the narrative.

2. The computer-implemented method of claim 1, wherein the recommending of the content item to be included in the narrative further comprises:
recommending a posting of the narrative, wherein the narrative corresponds to a new narrative, and wherein the narrative includes at least a portion of the content item.

3. The computer-implemented method of claim 2, further comprising:
receiving one or more user instructions to modify the narrative including the at least the portion of the content item; and
modifying the narrative based on the one or more user instructions.

4. The computer-implemented method of claim 1, wherein the narrative corresponds to an existing narrative, and wherein the existing narrative is created prior to detecting that the content item has been published.

5. The computer-implemented method of claim 4, wherein the narrative is created based on at least one user instruction to create the narrative.

6. The computer-implemented method of claim 4, further comprising:
receiving, prior to detecting that the content item has been published, a selection of at least one other content item to be included in the narrative; and
including the at least one other content item in the narrative.

7. The computer-implemented method of claim 1, wherein the narrative includes at least one of a subject, a topic, or a theme associated with a user of a social networking system, and wherein the likelihood that the content item is associated with the narrative depends, at least in part, on a level of relevancy of the content item with respect to the at least one of the subject, the topic, or the theme.

8. The computer-implemented method of claim 7, wherein the confidence metric for the content item and the likelihood that the content item is associated with the narrative increase when the level of relevancy of the content item with respect to the at least one of the subject, the topic, or the theme is higher, and wherein the confidence metric for the content item and the likelihood that the content item is associated with the narrative decrease when the level of relevancy of the content item with respect to the at least one of the subject, the topic, or the theme is lower.

9. The computer-implemented method of claim 7, wherein the at least one of the subject, the topic, or the theme is determined based on at least one of a pattern of posts published by the user or a user command.

10. The computer-implemented method of claim 7, wherein the content item is a node in a graph infrastructure associated with the user of the social networking system, and wherein the acquiring of the information about the content item further comprises:
performing a search of the graph infrastructure to acquire the information about the content item.

11. The computer-implemented method of claim 7, wherein the acquiring of the information about the content item further comprises:
performing batch processing with respect to a data warehouse of the social networking system to acquire the information about the content item from the data warehouse.

12. The computer-implemented method of claim 7, wherein the analyzing of the information about the content item to determine the confidence metric for the content item further comprises:
analyzing the information to determine that the content item is associated with one or more defined classifiers, wherein the confidence metric is determined based on the one or more defined classifiers.

13. The computer-implemented method of claim 12, wherein the one or more defined classifiers include at least one of a travel classifier, an event classifier, or a tag classifier.

14. The computer-implemented method of claim 1, wherein the content item includes at least one of an image, a video, an audio, a check-in, a status update, a shared post, a published post, an article, or text.

15. The computer-implemented method of claim 1, wherein the narrative is associated with a first user of a social networking system, and wherein the content item is published by at least one of the first user or a second user of the social networking system.

16. The computer-implemented method of claim 15, further comprising:
presenting the narrative including at least the content item at a profile associated with the first user of the social networking system.

17. The computer-implemented method of claim 16, wherein the presenting of the narrative including the content item further comprises:
presenting at least one of a map indicating a set of locations associated with the narrative.

18. The computer-implemented method of claim 16, further comprising:
presenting at least one other narrative associated with the first user; and
presenting at least one of a interface section or an interactive timeline from which the narrative and the at least one other narrative are accessible.

19. A system comprising:
at least one processor; and
a memory storing instructions that, when executed by the at least one processor, cause the system to perform:
detecting that a content item has been published;
acquiring information about the content item;
analyzing the information about the content item to determine a confidence metric for the content item, the confidence metric indicating a likelihood that the content item is associated with a narrative;
determining that the confidence metric for content item satisfies a specified threshold; and
recommending the content item to be included in the narrative.

20. A non-transitory computer-readable storage medium including instructions that, when executed by at least one processor of a computing system, cause the computing system to perform:
detecting that a content item has been published;
acquiring information about the content item;
analyzing the information about the content item to determine a confidence metric for the content item, the confidence metric indicating a likelihood that the content item is associated with a narrative;
determining that the confidence metric for content item satisfies a specified threshold; and
recommending the content item to be included in the narrative.
